(19) United States
(12) Patent Application Publication
(10) Pub. No.: US 2012/0177920 A1
(43) Pub. Date: Jul. 12, 2012

(54) ANTIGLARE AND ANTISEPTIC COATING MATERIAL AND TOUCHSCREEN COATED WITH THE SAME

(76) Inventor: Yu-Hui HUANG, Taoyuan County (TW)

(21) Appl. No.: 13/004,422

(22) Filed: Jan. 11, 2011

(51) Int. Cl. B32B 27/30; B32B 17/06; B32B 27/36; C07F 7/10; B32B 5/00; B82Y 30/00

(52) U.S. Cl. 428/402; 556/410; 428/446; 428/428; 428/451; 428/412; 977/773

(57) ABSTRACT

An antiglare and antiseptic coating material comprises nanoparticles with a molecule having the formula (I):

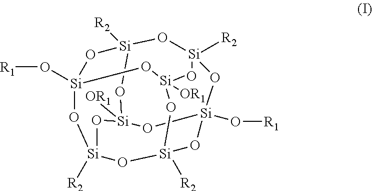

wherein R1 could be substituted with halogens, hydrogen, alkyl groups, alkoxy groups, hydroxyl group, alkenyl groups, alkynyl groups, acyl groups, aryl groups, carboxyl groups, alkoxycarbonyl groups, or aryloxycarboxyl groups, and wherein R2 could be quaternary ammonium functional groups. The antiglare and antiseptic coating material is spread on an outer cover or a conductive layer of a touchscreen to provide antiglare, antiseptic and fingerprint-proof functions for the coated surfaces.

### FIELD OF THE INVENTION

The present invention relates to a coating material and a touchscreen coated with the same, particularly to an antiglare and antiseptic coating material and a touchscreen coated with the same.

### BACKGROUND OF THE INVENTION

In comparison with the conventional input devices, a touchscreen allows a user to input instructions with his finger intuitively. Besides, a touchscreen features superior human-machine interaction and has advantages of fast operation, high precision and small volume. Therefore, touchscreens have gradually replaced conventional input devices, such as keyboards or mice, and has been extensively used in various consumer electronics, such as person computers, mobile communication devices, portable media players, or electronic books. At present, most of the touchscreens available in the market belong to the resistive type or the capacitive type.

The basic structure of a resistive touchscreen includes two ITO (Indium Tin Oxide) films and a plurality of point-type spacers. The point-type spacers are arranged between the ITO films to separate them by a specified distance. When a user contacts the ITO film, a conduction state occurs in the ITO films and causes a resistance variation. Via the resistance variation, a sensor determines the coordinates of the contact point. However, the resistive touchscreen using ITO films has disadvantages of poor light transmittance and low wear resistance. Besides, ITO films may distort after long-term and repeated compression.

The capacitive touchscreens are developed to overcome the abovementioned problems. According to their structures, the capacitive touchscreens may be categorized into the surface type and the projective type. The surface type capacitive touchscreen includes a glass substrate, a conductive film formed on the glass substrate, a patterned electrode on the conductive film, and a wear-resistant layer covering the abovementioned components. The surface type capacitive touchscreen provides voltage from the four corners to generate a uniform electric field. When a user contacts the touchscreen with his finger, the electric field would be changed. A controller determines the contact point via detecting the ratio of induced currents from the different corners. The projective type capacitive touchscreen includes a glass substrate and an arrayed ITO electrode layer on the glass substrate. When a user contacts the touchscreen with his finger, the capacitance of the electrode layer would be changed. The contact point is determined via the capacitance variation.

No matter what type the touchscreen is, users have to touch the surface of the touchscreen to input instructions or operate the computer. Electronic devices with the touchscreens installed in public spaces are very frequently used by many people and likely to spread microbes and bacteria.

In order to solve the abovementioned problem, antiseptic materials are intended to apply to the surface of touchscreens. Common antiseptic materials include antibiotics, nanometric inorganic antiseptic agents, or other organic antiseptic agents, which are gradually released to inhibit or kill bacteria. For example, a Taiwan patent No. I272110 disclosed a touchscreen with an antiseptic layer and a method for fabricating the same, wherein a type of antiseptic metallic particles having a diameter of 1-100 nm are uniformly coated on the surface of a touchscreen to form an antiseptic layer, and wherein the antiseptic metallic particles are made of gold, silver, copper, zinc, platinum, or a compound thereof. Taiwan publication No. 200727163 disclosed a technology of forming an antiseptic layer on the top surface of the upper substrate of a touchscreen, and wherein the antiseptic layer may contain nanometric silver particles. The abovementioned antiseptic metallic materials have biochemical activity. When the antiseptic metallic material penetrates the cell walls of bacteria, it denatures intracellular enzyme proteins of bacteria and kills the bacteria. The service life of the antiseptic agent can be prolonged via modifying the concentration or decreasing the releasing speed. However, the antiseptic agent would be exhausted finally. Thus, it must be applied to the touchscreen once again. Besides, the above-mentioned nanometric metallic materials are hard to form secure bonding with a touchscreen but likely to adhere to the matters contacting it, such as user's fingers. Thus, the abovementioned antiseptic metallic materials may poison human beings and contaminate the environment.

In addition, U.S. Pat. No. 6,504,583 disclosed an antiseptic material for touchscreens, which is a derivative of an alkyl quaternary ammonium salt. The alkyl quaternary ammonium salt has positive charge. When contacting the negatively-charged surface of bacteria, the positively-charged alkyl quaternary ammonium salt destroys the charge balance of cell membranes, which may disable metabolism of the neighboring organelles or even rupture the cell membranes and expose the cytoplasm. In comparison with the abovementioned antiseptic metallic materials, the alkyl quaternary ammonium salt antiseptic agents needn't directly take part in bacteria-killing activity but functions as a catalyst to damage charge balance of cells. Therefore, the concentration of the alkyl quaternary ammonium salt antiseptic agents would be maintained. However, the alkyl quaternary ammonium salt antiseptic agents are also hard to form secure bonding with a touchscreen and likely to peel off from the touchscreen. Therefore, the antiseptic effect thereof will obviously decrease with usage.

When coated on the surface of a touchscreen, these kinds of conventional antiseptic materials would form a transparent film which makes the surface of the touchscreen very smooth and becomes a mirror-like (glassy) surface. Under intense light, the glassy surface generates glare that makes the user unable to view the contents presented on the touchscreen. On the other hand, when the user contacts a touchscreen with a dusty or oily finger, the dust or fingerprint will be left on the touchscreen and impair the appearance of the touchscreen.

### SUMMARY OF THE INVENTION

The primary objective of the present invention is to solve the problem that the conventional alkyl quaternary ammonium salt antiseptic agents would peel off from touchscreens, the problem that the conventional inorganic metallic antiseptic agents would stick to users' fingers and pollute the environment, and the problem that the conventional antiseptic agents would generate glare and visualize fingerprints.

To achieve the abovementioned objectives, the present invention provides an antiglare and antiseptic coating material comprising nanoparticles with a molecule having the formula (I):

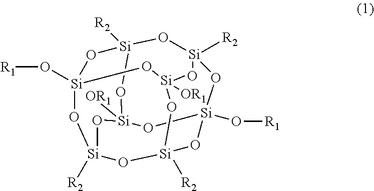

wherein R1 could be substituted with halogens, hydrogen, alkyl groups, alkoxy groups, the hydroxyl group, alkenyl groups, alkynyl groups, acyl groups, aryl groups, carboxyl groups, alkoxycarbonyl groups, and aryloxycarboxyl groups, and wherein R2 could be a quaternary ammonium functional groups.

The present invention also discloses an antiglare and antiseptic touchscreen which has a conductive layer to be coated with the abovementioned antiglare and antiseptic coating material.

The present invention also discloses an antiglare and antiseptic touchscreen which has an outer cover to be coated with the abovementioned antiglare and antiseptic coating material.

The antiglare and antiseptic coating material of the present invention has the following advantages:
1. In comparison with the conventional antiseptic agents applied to touchscreens, such as the alkyl quaternary ammonium salt antiseptic agents and the inorganic metallic antiseptic agents, the antiglare and antiseptic coating material of the present invention has higher weather resistance and superior antiglare and antiseptic effect.
2. The antiglare and antiseptic coating material of the present invention would not peel off from touchscreens but can securely adhere to surfaces of touchscreens via the silicon functional groups thereof. Therefore, the antiglare and antiseptic coating material of the present invention neither poisons human bodies nor pollutes the environment. Further, the service life thereof is increased.
3. After the antiglare and antiseptic coating material has been coated on a touchscreen, the spherical structure of the nanoparticles generates a matte surface, which can prevent the appearance of the screen from being affected by dirt or fingerprints.

### DETAILED DESCRIPTION OF THE PREFERRED EMBODIMENTS

The present invention discloses an antiglare and antiseptic coating material, which contains nanoparticles with a molecule having the formula (I):

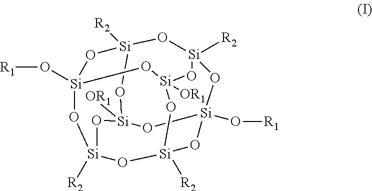

R1 could be substituted with halogens, hydrogen, alkyl groups, alkoxy groups, the hydroxyl group, alkenyl groups, alkynyl groups, acyl groups, aryl groups, carboxyl groups, alkoxycarbonyl groups, or aryloxycarboxyl groups. Preferably, R1 could be substituted with —H, —OH, —OCH₃, —OC₂H₅, —CH₃, —CH═CH₂, —OC₂H₄OCH₃ and —C₃H₆COOC₂H₅. R2 could be quaternary ammonium functional groups.

The antiglare and antiseptic coating material of the present invention is fabricated via adding stabilizers into a sol-gel with silicon functional groups (SiOₓ) and organic molecules. The molecules in a sol-gel state are interacted mutually by non-covalent bonds, such as hydrogen bonds, Van der Waals force, and coordinate bonds, to form supermolecules. Thereby, the sol-gel has superior uniformity, dispersiveness and stability. After added into the abovementioned sol-gel, the stabilizers retard the growth of a portion of particles. Thereby is formed a plurality of transparent spherical nanoparticles. In the present invention, the stabilizers could be organic amines (such as trioctylamine, octylamine, dodecylamone, hexylamine, pyridine, oleamine, quaternary ammonium groups), thiols (such as octylthiol groups, dodecylthiol groups, and thiophenol groups), phosphino compounds (such as triphenylphosphonio groups, tributylphosphino groups, and trioctylphosphino groups), acids (such as sulfuric acid, nitric acid, hydrochloric acid, acetic acid, and sodium sulfate), bases (such as sodium hydroxide, potassium hydroxide and ammonium hydroxide), alcohol groups (such as methanol, ethanol, ethylene glycol, propanol, and isopropanol), or alkyl groups (methane, ethane, propane, butane, pentane, hexane, heptane, octane, dodecane, tridecane, tetradecane, pentadecane, hexadecane, heptadecane, and octadecane). In the present invention, the nanoparticles have a diameter of 100-200 nm.

The antiglare and antiseptic coating material of the present invention can be applied to various touchscreens. For example, the coating material of the present invention can be coated on a conductive layer of a touchscreen to form an antiseptic layer containing the nanoparticles, wherein the conductive layer is made of ITO (Indium Tin Oxide), ATO (Antimony Tin Oxide), AZO (Aluminum Zinc Oxide), or IZO (Indium Zinc Oxide). The coating material can also be coated on the outer cover of a touchscreen, wherein the outer cover is made of glass, PMMA (poly(methyl methacrylate)), PVC (PolyVinyl Chloride), PC (PolyCarbonate), PET (poly(ethylene terephthate)), or PI (polyimide). After being coated on the conductive layer or the outer cover of a touchscreen, the coating material is heated at a temperature of 25-250° C. Thereby, covalent bonds are formed between the surface of the conductive layer (or outer cover) and the silicon functional groups of the nanoparticles. The covalent bonds make the antiseptic layer securely adhere to the surface and hard to peel off.

A nanoparticle has a high specific surface area and a high specific surface atom number. The high surface chemical activity of the nanoparticles and the high chemical activity of the quaternary ammonium functional groups are very likely to reduce the water molecules and oxygen molecules into hydroxyl (—OH) and superoxide (O₂—). hydroxyl (—OH) and superoxide (O₂—), which can penetrate into bacteria or viruses to damage the enzyme system thereof. Thus are killed bacteria or viruses without harming human beings or the environment.

Below are described in detail the embodiments of the present invention to demonstrate the method for fabricating a touchscreen coated with the antiglare and antiseptic coating material, the wear resistance and antiseptic effect thereof.

### Embodiment I

### a Process to Fabricate a Touchscreen Coated with an Antiglare and Antiseptic Coating Material

Firstly, the coating material is coated directly on a PMMA outer cover. Alternatively, the antiglare and antiseptic coating material is diluted and then coated on a PMMA outer cover. The material can be diluted with a solvent, such as alcohol groups (such as isopropanol or ethanol), ketone groups, ether groups, or benzene. In the present invention, the antiglare and antiseptic coating material can be diluted with 1000 times of solvent to have a concentration of 0.1 v/v %. In dilution, the coating material is mixed with the solvent to form a mixture solution, and the mixture solution is agitated in a mechanical way. For example, the mixture solution is agitated with blades; or the mixture solution is agitated with a rotation agitator; the mixture solution is oscillated up and down; the mixture solution is contained in a roller, and the roller is rolled back and forth. When reaching achieves a homogeneous and high-dispersiveness state, the mixture solution is coated on the outer cover via spray coating, dip coating, roll coating, print coating, or spin coating. Next, the outer cover coated with the coating material is placed in an environment at a temperature of 25-250° C. for at least one minute, whereby the coating material adheres to the outer cover. Then, the outer cover is cooled down. Thus is formed an antiglare and antiseptic coating on the outer cover. The gloss of the outer cover coated with the coating material can be controlled to be 15 to 150 GU (Gloss Unit).

### Embodiment II

### Weather Resistance Tests of Outer Covers Coated with the Antiglare and Antiseptic Coating Material

High temperature tests, low temperature tests, high humidity tests and thermal shock tests on the coated outer covers are performed as follows.

### (1) High Temperature Tests:

20 pieces of 5 cm×5 cm outer covers coated with the antiglare and antiseptic coating material of the present invention are prepared. A gloss meter is used to test the gloss of the coated outer covers initially and test them again after the outer covers are placed in an environment at a temperature of 80° C. for 200 hours. The results are as follows:

| | Results Before | Results After Placed |
|---|---|---|
| Serial Number of | Placed at High | at High Temperature |
| Group | Temperature (GU) | (GU) |
| 1 | 100 | 105 |
| 2 | 105 | 100 |
| 3 | 101 | 101 |
| 4 | 100 | 100 |
| 5 | 99 | 100 |
| 6 | 98 | 100 |
| 7 | 95 | 97 |
| 8 | 105 | 106 |
| 9 | 108 | 109 |
| 10 | 100 | 100 |
| 11 | 100 | 101 |
| 12 | 107 | 105 |
| 13 | 95 | 97 |
| 14 | 100 | 105 |
| 15 | 108 | 105 |
| 16 | 105 | 105 |
| 17 | 106 | 101 |
| 18 | 100 | 101 |
| 19 | 100 | 101 |
| 20 | 107 | 105 |

### (2) Low Temperature Tests:

20 pieces of 5 cm×5 cm outer covers coated with the antiglare and antiseptic coating material of the present invention are prepared. A gloss meter are used to test the gloss of the coated outer covers initially and test them again after the outer covers are placed in an environment at a temperature of −40° C. for 150 hours. The results are as follows:

| | Results Before | Results After Placed |
|---|---|---|
| Serial Number of | Placed at Low | at Low Temperature |
| Group | Temperature (GU) | (GU) |
| 1 | 105 | 104 |
| 2 | 100 | 100 |
| 3 | 101 | 101 |
| 4 | 100 | 101 |
| 5 | 109 | 108 |
| 6 | 105 | 105 |
| 7 | 95 | 95 |
| 8 | 95 | 97 |
| 9 | 100 | 98 |
| 10 | 101 | 99 |
| 11 | 108 | 105 |
| 12 | 107 | 105 |
| 13 | 100 | 103 |
| 14 | 105 | 100 |
| 15 | 100 | 101 |
| 16 | 105 | 105 |
| 17 | 106 | 106 |
| 18 | 100 | 101 |
| 19 | 100 | 100 |
| 20 | 105 | 105 |

### (3) High Humidity Tests:

20 pieces of 5 cm×5 cm outer covers coated with the antiglare and antiseptic coating material of the present invention are prepared. A gloss meter to is used to test the gloss of the coated outer covers initially and test them again after the outer covers are placed in an environment at a temperature of 50° C. and a relative humidity of 90% for 200 hours. The results are as follows:

| | Results Before | Results After Placed |
|---|---|---|
| Serial Number of | Placed at High | at High Humidity |
| Group | Humidity (GU) | (GU) |
| 1 | 101 | 106 |
| 2 | 105 | 105 |
| 3 | 101 | 103 |
| 4 | 100 | 103 |
| 5 | 109 | 108 |
| 6 | 105 | 105 |
| 7 | 100 | 100 |
| 8 | 105 | 105 |
| 9 | 100 | 99 |
| 10 | 94 | 97 |
| 11 | 99 | 101 |
| 12 | 107 | 105 |
| 13 | 100 | 100 |
| 14 | 105 | 106 |
| 15 | 100 | 100 |
| 16 | 101 | 105 |
| 17 | 106 | 101 |
| 18 | 100 | 101 |
| 19 | 100 | 100 |
| 20 | 101 | 106 |

### (4) Thermal Shock Tests:

20 pieces of 5 cm×5 cm outer covers coated with the antiglare and antiseptic coating material of the present invention are prepared. A gloss meter is used to test the gloss of the coated outer covers initially and test them again after the outer covers are placed at a temperature of 80° C. for 15 minutes and then −40° C. for 30 minutes cyclically 40 times. The results are as follows:

| Serial Number of | Results Before | Results After |
|---|---|---|
| Group | Thermal Shock (GU) | Thermal Shock (GU) |
| 1 | 95 | 100 |
| 2 | 100 | 105 |
| 3 | 102 | 101 |
| 4 | 100 | 100 |
| 5 | 99 | 98 |
| 6 | 105 | 105 |
| 7 | 100 | 100 |
| 8 | 103 | 105 |
| 9 | 103 | 106 |
| 10 | 100 | 100 |
| 11 | 96 | 98 |
| 12 | 97 | 97 |
| 13 | 100 | 99 |
| 14 | 105 | 104 |
| 15 | 100 | 100 |
| 16 | 105 | 105 |
| 17 | 106 | 106 |
| 18 | 100 | 101 |
| 19 | 100 | 101 |
| 20 | 105 | 107 |

The results of the above several weather resistance tests prove that the outer cover coated with the antiglare and antiseptic coating material still possesses superior antiglare performance after the tests of high temperature, low temperature, high humidity and thermal shock.

### Embodiment III

### Antiseptic Effect Tests of the Outer Covers Coated with the Antiglare and Antiseptic Coating Material

The Escherichia coli of Gram positive bacteria are used to verify the effect of the antiseptic touchscreen of the present invention. 20 pieces of 5 cm² PMMA outer covers coated with the antiglare and antiseptic coating material (an experimental group) and 20 pieces of 5 cm² uncoated PMMA outer covers (a control group) are prepared respectively. 10⁵ CFU/ml Escherichia coli are spread onto the outer covers of the experimental group and the control group. Next, the outer covers are incubated at a temperature of 35° C. for 24 hours. Next, these outer covers are flushed with 50 ml of a sterile phosphate buffer to remove dead Escherichia coli. Next, the bacteria colonies surviving on the outer covers are counted. The results are as follows:

| Serial Number of | Results of Control | Results of Experimental |
|---|---|---|
| Group | Group (CFU/ml) | Group (CFU/ml) |
| 1 | 1.0*10⁵ | 1.0*10² |
| 2 | 3.1*10⁶ | 1.0*10³ |
| 3 | 2.5*10⁵ | 1.5*10³ |
| 4 | 4.0*10⁵ | 1.1*10² |
| 5 | 5.0*10⁵ | 1.5*10³ |
| 6 | 2.0*10⁶ | 1.2*10³ |
| 7 | 2.3*10⁵ | 4.1*10² |
| 8 | 6.1*10⁵ | 2.6*10² |
| 9 | 4.5*10⁵ | 3.1*10² |
| 10 | 3.4*10⁵ | 3.0*10¹ |
| 11 | 4.1*10⁵ | 1.4*10² |
| 12 | 1.0*10⁵ | 1.1*10³ |
| 13 | 1.4*10⁵ | 1.5*10² |
| 14 | 1.2*10⁵ | 2.2*10² |
| 15 | 5.1*10⁵ | 1.3*10² |
| 16 | 8.3*10⁷ | 6.3*10² |
| 17 | 4.5*10⁶ | 4.3*10³ |
| 18 | 2.9*10⁵ | 6.9*10² |
| 19 | 4.0*10⁵ | 3.1*10² |
| 20 | 2.9*10⁶ | 1.0*10³ |

From the results, it is known: the outer covers coated with the antiglare and antiseptic coating material of the present invention have much higher antiseptic effect than the uncoated outer covers.

### Embodiment IV

### Weather Resistance Tests of the Antiseptic Effect of the Outer Covers Coated with the Antiglare and Antiseptic Coating Material of the Present Invention

In this embodiment, high temperature tests, low temperature tests, high humidity tests and thermal shock tests are performed on PMMA outer covers coated with the antiglare and antiseptic coating material of the present invention (an experimental group) and uncoated PMMA outer covers (a control group) respectively. 10⁵ CFU/ml Escherichia coli are spread onto the outer covers of the experimental group and the control group. Next, the outer covers are incubated at a temperature of 35° C. for 24 hours. Next, the outer covers are flushed with 50 ml of a sterile phosphate buffer to remove dead Escherichia coli. Next, the bacteria colonies surviving on the outer covers are counted.

### (1) High Temperature Tests:

5 pieces of 5 cm×5 cm coated outer covers (an experimental group) and 5 pieces of 5 cm×5 cm uncoated outer covers (a control group) are prepared. The outer covers are placed in an environment at a temperature of 80° C. for 200 hours. Then, the antiseptic effect tests mentioned above are undertaken. The results are as follows:

| Serial Number of | Results of Control | Results of Experimental |
|---|---|---|
| Group | Group (CFU/ml) | Group (CFU/ml) |
| 1 | 2.0*10⁵ | 1.2*10² |
| 2 | 3.0*10⁷ | 2.2*10⁴ |
| 3 | 5.4*10⁶ | 1.0*10³ |
| 4 | 3.1*10⁵ | 1.5*10² |
| 5 | 7.5*10⁶ | 1.2*10³ |

### (2) Low Temperature Tests:

5 pieces of 5 cm×5 cm coated outer covers (an experimental group) and 5 pieces of 5 cm×5 cm uncoated outer covers (a control group) are prepared. The outer covers are placed in an environment at a temperature of −40° C. for 150 hours. Then, the antiseptic effect tests mentioned above are undertaken. The results are as follows:

| Serial Number of | Results of Control | Results of Experimental |
|---|---|---|
| Group | Group (CFU/ml) | Group (CFU/ml) |
| 1 | 4.1*10⁶ | 1.0*10³ |
| 2 | 1.8*10⁶ | 2.0*10² |
| 3 | 2.0*10⁵ | 1.5*10² |
| 4 | 1.8*10⁵ | 1.2*10² |
| 5 | 4.0*10⁵ | 2.6*10² |

### (3) High Humidity Tests:

5 pieces of 5 cm×5 cm coated outer covers (an experimental group) and 5 pieces of 5 cm×5 cm uncoated outer covers (a control group) are prepared. The outer covers are placed in an environment at a temperature of 50° C. and a relative humidity of 90% for 200 hours. Then, the antiseptic effect tests mentioned above are undertaken. The results are as follows:

| Serial Number of | Results of Control | Results of Experimental |
|---|---|---|
| Group | Group (CFU/ml) | Group (CFU/ml) |
| 1 | 4.4*10⁵ | 2.0*10³ |
| 2 | 6.5*10⁵ | 1.6*10³ |
| 3 | 5.2*10⁵ | 1.0*10³ |
| 4 | 5.8*10⁶ | 8.0*10² |
| 5 | 4.8*10⁵ | 1.7*10² |

### (4) Thermal Shock Tests:

5 pieces of 5 cm×5 cm coated outer covers (an experimental group) and 5 pieces of 5 cm×5 cm uncoated outer covers (a control group) are prepared. The outer covers are placed at a temperature of 80° C. for 15 minutes and then −40° C. for 30 minutes cyclically 40 times. Then, the antiseptic effect tests mentioned above are undertaken. The results are as follows:

| Serial Number of | Results of Control | Results of Experimental |
|---|---|---|
| Group | Group (CFU/ml) | Group (CFU/ml) |
| 1 | 5.0*10⁵ | 1.2*10³ |
| 2 | 5.3*10⁶ | 1.5*10³ |
| 3 | 5.0*10⁶ | 8.8*10² |
| 4 | 5.9*10⁶ | 1.1*10³ |
| 5 | 7.7*10⁵ | 2.0*10² |

The results show that high temperature, low temperature, high humidity and thermal shock would not affect the antiseptic function of the present invention.

### Embodiment V

### Wear Resistance Tests of the Antiseptic Effect of the Outer Covers Coated with the Antiglare and Antiseptic Coating Material of the Present Invention

10 pieces of 5 cm×5 cm outer covers coated with the antiglare and antiseptic coating material of the present invention (an experimental group) and 10 pieces of 5 cm×5 cm uncoated outer covers (a control group) are prepared. A wear test machine is used to abrade the outer covers with a load of 500 g for 500 cycles. Then, 10⁵ CFU/ml Escherichia coli are spread onto the abraded outer covers of the experimental group and the control group. Next, the outer covers are incubated at a temperature of 35° C. for 24 hours. Next, the outer covers are flushed with 50 ml of a sterile phosphate buffer to remove dead Escherichia coli. Next, the bacteria colonies surviving on the outer covers are counted. The results are as follows:

| Serial Number of | Results of Control | Results of Experimental |
|---|---|---|
| Group | Group (CFU/ml) | Group (CFU/ml) |
| 1 | 2.0*10⁵ | 1.0*10⁴ |
| 2 | 2.3*10⁵ | 1.5*10³ |
| 3 | 2.0*10⁵ | 1.8*10³ |
| 4 | 1.9*10⁵ | 1.1*10³ |
| 5 | 2.7*10⁵ | 1.8*10³ |
| 6 | 3.0*10⁵ | 1.0*10⁴ |
| 7 | 2.3*10⁵ | 1.5*10³ |
| 8 | 3.0*10⁵ | 1.3*10³ |
| 9 | 2.9*10⁵ | 1.6*10³ |
| 10 | 1.7*10⁵ | 2.6*10² |

The results show that the outer covers coated with the antiglare and antiseptic coating material of the present invention still possess superior antiseptic function after 500 cycles of abrasions and that the antiglare and antiseptic coating material of the present invention has superior wear resistance.

In conclusion, the antiglare and antiseptic coating material of the present invention uses the nanoparticles containing quaternary ammonium functional groups to achieve superior antiseptic effect and uses the spherical structure of the nanoparticles to generate a matte effect and provide an antiglare function for a touchscreen screen. Further, the matte effect can exempt the appearance of the touchscreen from being affected by dirt or fingerprints. Furthermore, the silicon function groups of the nanoparticles enable the coating material to securely adhere to an outer cover or a conductive layer of a touchscreen via covalent bonds, whereby the coating material neither peels off nor lose its antiseptic ability in usage. Therefore, the present invention possesses utility, novelty and non-obviousness and meets the condition for a patent. Thus, the Inventor files the application for a patent. It will be appreciated if the patent is approved fast.

The embodiments described above are only to exemplify the present invention but not to limit the scope of the present invention. Any equivalent modification or variation according to the spirit of the present invention is to be also included within the scope of the present invention.

What is claimed is:

1. An antiglare and antiseptic coating material comprising:
nanoparticles with a molecule having the formula (I): 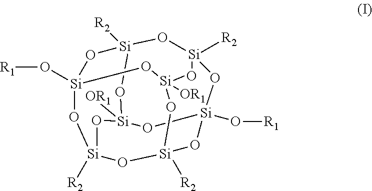
wherein R1 is selected from a group consisting of halogens, hydrogen, alkyl groups, alkoxy groups, hydroxyl group, alkenyl groups, alkynyl groups, acyl groups, aryl groups, carboxyl groups, alkoxycarbonyl groups, and aryloxycarboxyl groups; and
wherein R2 is a quaternary ammonium functional group.

2. The antiglare and antiseptic coating material according to claim 1, wherein R1 of the formula (I) is selected from a group consisting of —H, —OH, —OCH₃, —OC₂H₅, —CH₃, —CH═CH₂, —OC₂H₄OCH₃ and —C₃H₆COOC₂H₅.

3. The antiglare and antiseptic coating material according to claim 1, wherein the nanoparticles has a diameter of 100-200 nm.

4. An antiglare and antiseptic touchscreen comprising a conductive layer where the antiglare and antiseptic coating material according to claim 1 is coated.

5. The antiglare and antiseptic touchscreen according to claim 4, wherein the conductive layer is made of a material selected from a group consisting of Indium Tin Oxide, Antimony Tin Oxide, Aluminum Zinc Oxide, and Indium Zinc Oxide.

6. An antiglare and antiseptic touchscreen comprising an outer cover where the antiglare and antiseptic coating material according to claim 1 is coated.

7. The antiglare and antiseptic touchscreen according to claim 6, wherein the outer cover is made of a material selected from a group consisting of glass, poly(methyl methacrylate), PolyVinyl Chloride, PolyCarbonate, poly(ethylene terephthate), and polyimide.
